(19) United States
(12) Patent Application Publication
(10) Pub. No.: US 2012/0007818 A1
(43) Pub. Date: Jan. 12, 2012

(54) OPERATIONAL AUTHORITY SWITCHING DEVICE WITH TOUCH PANELS AND PROGRAM

(75) Inventor: Hiroyuki Koga, Saitama (JP)

(73) Assignee: SONY CORPORATION, Tokyo (JP)

(21) Appl. No.: 13/164,981

(22) Filed: Jun. 21, 2011

(30) Foreign Application Priority Data
Jul. 12, 2010 (JP) 2010-158228

(51) Int. Cl. G06F 3/041

(52) U.S. Cl. 345/173

(57) ABSTRACT

An operational authority switching device with touch panels includes a plurality of display panels; a plurality of touch panels provided so as to be paired with each of the plurality of display panels; a plurality of switching buttons provided so as to be paired with each of the plurality of touch panels; a storage portion storing an operational authority switching program for switching the operational authority on the plurality of touch panels; a control portion executing an operational authority switching program stored in the storage portion; a display processing portion generating images based on instructions of the control portion; and a division portion dividing the images generated in the display processing portion into a plurality of areas and outputting each image corresponding to the divided areas to each of the plurality of display panels.

### BACKGROUND

The present disclosure relates to an operational authority switching device with touch panels and to a program. Specifically, the present disclosure relates to a technique of switching the operational authority on a touch panel device in a substrate producing apparatus or the like among a plurality of operators.

Hitherto, a plurality of mounters or the like has been connected to a mounting line of a substrate producing apparatus for producing a circuit substrate by mounting electronic components on a printed substrate. In the mounting line, operation panels are provided in the front and rear surface (surfaces opposite to each other while the mounting line is interposed therebetween) of the mounter or the like for the convenience of operators who operate the mounter or the like when maintenance tasks such as an adjustment and component replacement are necessary. However, when a plurality of operators performs the maintenance tasks, due to convenience, operations performed with respect to the front and rear operation panels conflict with the maintenance tasks, which causes problems in the maintenance tasks in some cases. Accordingly, since it is necessary that the operational authority on the front and rear operation panel is switched, the respective operation panels have been controlled by two computers such as personal computers (hereinafter referred to as “PCs”) in the past.

For example, a mounter 100 shown in FIG. 10 is provided with an operation panel having graphical user interfaces 101F and 101R including display panels and touch panels in front and rear surfaces (operation panels), switching buttons 103F and 103R and computers 102F and 102R. The operators switch the operational authority by using the switching buttons 103F and 103R disposed in the operation panel of each operator side.

Incidentally, there is a disclosed a technique in which a coordinate information input process is automatically performed by priority by a coordinate input device in use without performing a special mode setting operation (see Japanese Unexamined Patent Application Publication No. 2002-91898). In the technique disclosed in Japanese Unexamined Patent Application Publication No. 2002-91898, for example, in a case where a meeting is held using an electronic board or the like with a pen and a mouse, even when a person writes on the electronic board with a pen, the input is not interrupted by another person who uses a mouse to write.

### SUMMARY

However, when a touch panel mounted on an operation panel on the front and rear surfaces of a mounter or the like is a serial I/O device, unless operations of transmitting and receiving serial communication data are completely stopped, an invalidation process of the touch panel, that is, of the device, is not guaranteed. Therefore, when the touch panel is a serial I/O device, it takes several seconds of switching time to perform the operation of invalidating the device at one side, so an instant switching request from the other side fails to be satisfied.

Furthermore, the technique in Japanese Unexamined Patent Application Publication No. 2002-91898 aims to prevent a plurality of position input devices (pen and mouse, for example) from competing with each other for a coordinate information input process with respect to one device such as an electronic board. In other words, for example, just like the touch panels provided on the operation panels on the front and rear surfaces of the mounter or the like in a substrate producing apparatus, operation areas are not allocated for each operator, and operation authorities with respect to two operation areas are not switched.

Moreover, the touch panel mounted on the operation panel is controlled by a driver exclusive to each of a plurality of makers; therefore, it is necessary to perform different switching operations for each touch panel unit to be used, and a method of using driver software is not used in general.

According to the present disclosure, it is desirable to control a plurality of pointing devices (touch panels, for example) by one computer and to maintain the same operability as in a case where a plurality of computers is used.

According to the present disclosure, switching of the operation authorities on a plurality of touch panels by software is realized by using one computer. A valid operation area (a touch panel, for example) is selected by a hardware switching button. Electric signals generated by a touch panel device are valid all the time, and an invalidation process of the touch panel device itself is not performed. For example, the validity and invalidity of a pointer operation are determined according to the presence or absence of the operational authority, and only a valid event (message) is processed to realize switching of the operational authority. In order to realize this function, the following configurations are employed in the present disclosure.

According to an embodiment of the present disclosure, there is provided an operational authority switching device with touch panels including a plurality of display panels; a plurality of touch panels provided so as to be paired with each of the plurality of display panels; a plurality of switching buttons provided in association with each of the plurality of touch panels; a storage portion storing an operational authority switching program for switching the operational authority on the plurality of touch panels; a control portion executing an operational authority switching program stored in the storage portion; a display processing portion generating images based on instructions of the control portion; and a division portion dividing the images generated in the display processing portion into a plurality of areas and outputting each image corresponding to the divided areas to each of the plurality of display panels.

When one switching button is pushed, the control portion sets an operation area of the touch panel corresponding to the pushed switching button as a valid operation area to make operations with respect to the valid operation area of the corresponding touch panel valid.

According to an embodiment of the present disclosure, there is provided an operational authority switching program executed in an operational authority switching device with touch panels including a plurality of display panels; a plurality of touch panels provided so as to be paired with each of the corresponding plurality of display panels; a plurality of switching buttons provided in association with each of the corresponding plurality of touch panels; a display processing portion generating images; and a division portion dividing the images generated in the display processing portion into a plurality of areas and outputting each image corresponding to the divided areas to each of the plurality of display panels, the program causing a computer to function as a control portion which sets, when one switching button is pushed, an operation area of the touch panel corresponding to the pushed switching button as a valid operation area to make operations with respect to the valid operation area of the corresponding touch panel valid.

According to another embodiment of the present disclosure, there is provided an operational authority switching device with touch panels including a plurality of display panels; a plurality of touch panels provided so as to be paired with each of the corresponding plurality of display panels; and a control portion executing an operational authority switching program for switching operation authorities on the corresponding plurality of touch panels, wherein a valid operation area of each touch panel is limited to a display screen of the plurality of display panels set in association with each corresponding touch panel.

The control portion executes the operational authority switching program to switch the setting of the valid operation area with respect to each operation area of the plurality of touch panels, thereby exclusively controlling operations performed in the operation areas of the plurality of touch panels simultaneously.

According to another embodiment of the present disclosure, there is provided an operational authority switching program executed in an operational authority switching device with touch panels including a plurality of display panels; and a plurality of touch panels provided so as to be paired with each of the corresponding plurality of display panels, wherein a valid operation area of each touch panel is limited to a display screen of the plurality of display panels provided in association with each corresponding touch panel, the program causing a computer to function as a control portion which exclusively controls operations performed in the operation areas of the plurality of touch panels simultaneously by switching setting of the valid operation area with respect to each operation area of the plurality of touch panels.

According to the present disclosure, the operational authority switching program is executed to switch the setting of the valid operation area with respect to each operation area of the plurality of touch panels, thereby exclusively controlling operations performed in the operation areas of the plurality of touch panels simultaneously. In other words, when one switching button is pushed, the operation area of the touch panel corresponding to the pushed switching button is set to a valid operation area to make operations with respect to the valid operation area of the corresponding touch panel valid. As a result, switching of the operation authorities on a plurality of touch panels by software can be realized by using one computer (control portion).

According to the present disclosure, it is possible to control a plurality of pointing devices (touch panels, for example) using one computer (control portion) and to maintain the same operability as in a case where a plurality of computers is used.

### BRIEF DESCRIPTION OF THE DRAWINGS

FIG. 1 is a schematic view illustrating a configuration example of a substrate producing apparatus according to an embodiment of the present disclosure;

FIG. 2 is a schematic view illustrating the inside of a mounter of the substrate producing apparatus according to an embodiment of the present disclosure;

FIG. 3 is a block diagram illustrating an example of an internal configuration of a computer provided inside the mounter of the substrate producing apparatus according to an embodiment of the present disclosure;

FIG. 4 is a view illustrating area division and operation areas of an image according to an embodiment of the present disclosure;

FIG. 5 is a view illustrating an outline of an operational authority switching program according to an embodiment of the present disclosure;

FIG. 6 is a flowchart illustrating an operational authority switching process according to an embodiment of the present disclosure;

FIG. 7 is a flowchart illustrating a hooking process according to an embodiment of the present disclosure;

FIG. 8 is a flowchart illustrating a component replacement process according to an embodiment of the present disclosure;

FIG. 9 is a view illustrating a case where the operational authority switching technique of the present disclosure is applied to an interactive whiteboard; and

FIG. 10 is a schematic view illustrating the inside of a mounter of a substrate producing apparatus used in the past.

### DETAILED DESCRIPTION OF EMBODIMENTS

Hereinafter, examples of the embodiments of the present disclosure will be described with reference to the attached drawings. The description will be made in the following order. Furthermore, common portions in the drawings will be marked with the same reference numerals to omit or simplify repeated description.

1. An embodiment (an example of exclusively switching the operational authority by using one computer)

2. Another embodiment (an example where the present disclosure is applied to an interactive whiteboard)

### 1. An Embodiment

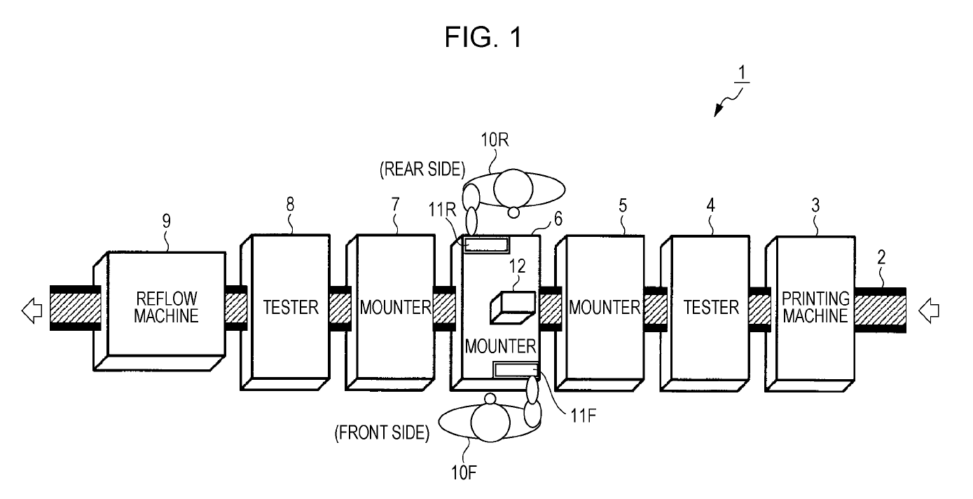

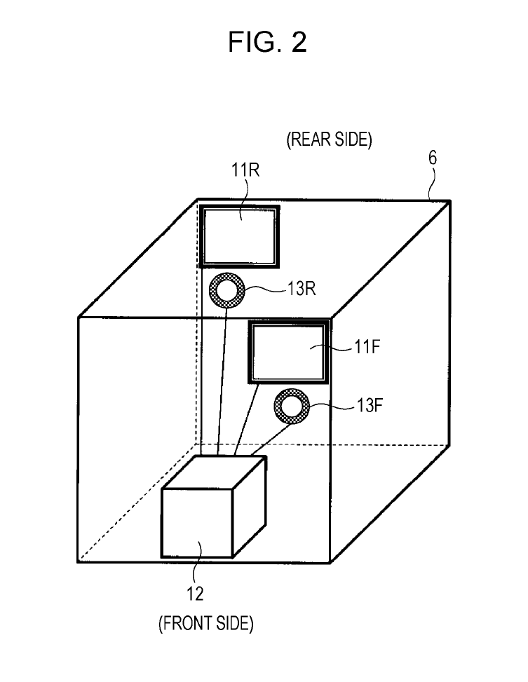

FIG. 1 is a schematic view illustrating a configuration example of a substrate producing apparatus according to an embodiment of the present disclosure, and FIG. 2 is a schematic view illustrating the inside of a mounter of the substrate producing apparatus. An example where an operational authority switching device with touch panels according to the present disclosure is applied to a mounter of a substrate producing apparatus will be described; however the present disclosure is not limited to this example.

Generally, in a substrate producing apparatus 1, a mounting line connects a plurality of process machines such as mounters by a substrate carrying conveyer 2 by which printed substrates flow. In these examples, a printing machine 3 printing circuit patterns or the like, a tester 4 testing a state after printing, mounters 5 to 7 mounting electronic components, a tester 8 testing a state after mounting and a reflow machine 9 performing soldering in a reflow method are provided.

In operation panels at the front side (Front) and the rear side (Rear) of the mounter 6, graphical user interfaces 11F and 11R are disposed respectively, and the graphical user interfaces 11F and 11R are provided with a display panel and a touch panel (not shown) respectively. Furthermore, in the operational panels at the front and rear sides of the mounter 6, switching buttons 13F and 13R are disposed respectively. Further, one computer 12 such as a personal computer is provided inside the mounter 6.

Moreover, although the mounter 6 is described as an example, the same configuration may be applied to a printing machine, a tester, a reflow machine and the like.

### [Switching of Operational Authority]

In this embodiment, the operational authority is switched by using mechanical buttons (switching buttons 13F and 13R).
By using the switching buttons 13F and 13R provided on the operation panels at the front and rear sides of the mounter, the operational authority is switched at the front and rear sides.
The operation authorities are mutually exclusive at the front and the rear sides.
At the side where the operational authority is present, other button operations performed in the operation panel, a touch panel operation and operations of external devices such as a mouse, a keyboard and a barcode reader can be performed.

An operator switches the operational authority by using the switching buttons 13F and 13R installed in the operation panel at each operator side. Also, by using one computer 12, switching of the operational authority of a plurality of graphical user interfaces 11F and 11R by software is realized.

### [Purpose of Switching Operational Authority]

There are two main purposes of switching the operation authorities.

### (1) Prevention of False Operation

When an unrelated person touches a touch panel at the rear side during an operation performed at the front side, by invalidating the operation performed in the touch panel at the rear side based on the operational authority, it is possible to prevent a false operation.
When an unrelated person operates a start button or the like at the rear side during an operation performed at the front side, a process machine starts to operate suddenly, which is dangerous; therefore, based on the operational authority, the operation performed in the touch panel at the rear side is invalidated.
   (2) Prevention of False Operation during a Series of Operations

When a series of operations such as calibration of the process machine is performed, if an operation is performed at the opposite side (a different touch panel device) in midstream, the process fails to be accurately completed in some cases. In this case, by making it so that switching of the operational authority is not possible until the series of operations are completed, the operation performed at the opposite side fails to be performed freely until the completion of the process. As a result, it is possible to prevent the false operation of a system such as the process machine or the substrate producing apparatus.

Operators 10F and 10R at the front and rear sides check contents of display panels and perform proper operations by using the touch panels when the operational authority is present at their sides. When the operator operates a component supply unit or a head at the front or rear side of the mounter, it is easier for the operator to operate the unit or the head from the corresponding side. Moreover, it takes time for the operator to move to operate the operation panel at the opposite side of the operator. Therefore, a configuration in which two operators operate the operation panels at the side that they deal with is more efficient.

Hereinafter, environments assumed in the embodiment will be listed.
There is a plurality of touch panels (an example of a pointing device) at each operator side.
A screen operation performed by each operator is exclusive; hence, while an operator performs an operation, the other operator is unable to perform an operation.
Among areas of screen output from a computer, a specific valid operation area is opened to each operator side, and each operator performs an operation only in each of the allocated valid operation areas.
The valid operation area allocated to each operator is not overlapped partially or entirely.
A computer provides different screen displays and services to each operator.

### [Internal Configuration of Computer]

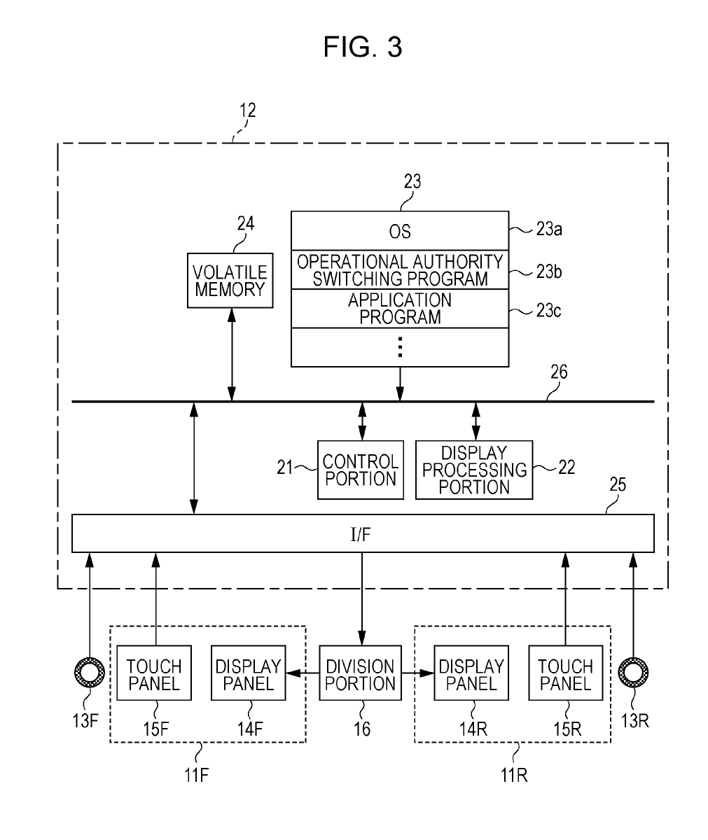

FIG. 3 is a block diagram illustrating an example of an internal configuration of the computer 12 provided inside the mounter of the substrate producing apparatus 1.

The computer 12 includes a control portion 21, a display processing portion 22, a non-volatile memory 23, a volatile memory 24, an interface (I/F) 25 and a bus 26.

An MPU (Micro-Processing Unit) is applied to the control portion 21 for example, and the control portion 21 performs various processes according to programs stored in a ROM (Read Only Memory) (not shown) and the non-volatile memory 23.

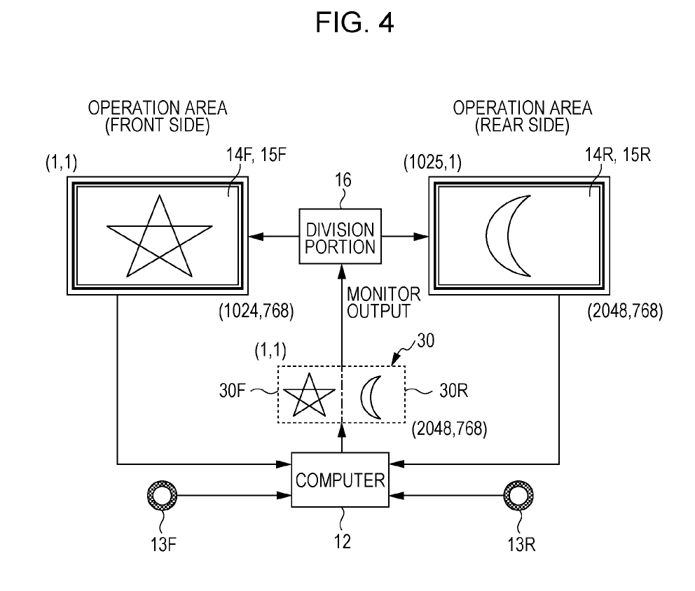

Based on the control of the control portion 21, the display processing portion 22 generates images (for example, an image 30 including areas 30F and 30R in FIG. 4) to be displayed on display panels 14F and 14R or performs image process and image modification with respect to the corresponding image.

The non-volatile memory 23 is a non-volatile storage portion including a semiconductor memory or the like. In this example, the non-volatile memory 23 stores data of an OS (Operating System) 23a, data of an operational authority switching program 23b, data of an application program 23c and the like. Furthermore, the non-volatile memory 23 may store data such as operation history of operators or the like and results of processes performed by the control portion 21, in addition to the program data.

The volatile memory 24 is a volatile storage portion and functions as a working memory when the control portion 21 reads and executes the program data from the non-volatile memory 23.

The I/F 25 exchanges data between input and output devices connected to the computer 12 and each portion of the computer 12. The data communication between respective portions inside the computer and between the input and output devices and respective portions of the computer 12 is performed via the bus 26.

The input and output devices connected to the computer 12 are graphical user interface 11F and 11R and the switching buttons 13F and 13R, which are disposed at the front and rear sides of the operation panel, and a division portion 16.

The graphical user interface 11F includes the display panel 14F and the touch panel 15F superimposed on the display panel 14F. A flat panel display such as a liquid crystal panel is applied as the display panel. The touch panel is an example of a position input device. Likewise, the graphical user interface 11R includes the display panel 14R and the touch panel 15R, and the function thereof is the same as the display panel 14F and the touch panel 15F. Furthermore, although the touch panel is superimposed on the display panel, a configuration in which the function as the display panel and the function as the touch panel are mounted on a single panel may be employed.

The switching buttons 13F and 13R are provided separately from the touch panels 15F and 15R for configuring the operation area described later, and push buttons (hardware) which open or close switches when pushed are applied as the switching buttons 13F and 13R. As the push button, any of an automatic reset type switch (a momentary switch or a push switch) which is turned ON only when being pushed and a position retaining type switch (an alternate switch or a push lock switch) which is turned ON and turned OFF whenever it is pushed may be used. That is, by using signals from the switching buttons 13F and 13R, the operational authority may be exclusively switched in the touch panels 15F and 15R at the front and rear sides of the operation panel.

The division portion 16 is a so-called display splitter. The division portion 16 divides images output from the computer 12 and outputs the resultants to the display panels 14F and 14R at the front and rear sides.

Next, area division of the image and operation areas according to the embodiment will be described with reference to FIG. 4.

As shown in FIG. 4, in the embodiment, the image 30 (for example, 2048×768 dot) output from the display processing portion 22 of the single computer 12 is divided into two areas 30F and 30R in the division portion 16, and the divided images are respectively output to the display panels 14F and 14R at the front and rear sides. That is, among the divided images of the image 30, an image corresponding to the area 30F is output to the display panel 14F as the operation area, and an image corresponding to the area 30R is output to the display panel 14R as the operation area. Accordingly, in this example, the area 30F corresponding to coordinates (1, 1) to (1024, 768) of the image 30 is displayed on the display panel 14F, and the area 30R corresponding to coordinates (1025, 1) to (2048, 768) of the image 30 is displayed on the display panel 14R.

When the operator pushes the switching buttons 13F and 13R provided on the operation panels at each operator side, the computer 12 detects this, and the operational authority is switched. This switching is performed exclusively.

The touch panels 15F and 15R are connected to the computer 12 separately, and operation ranges thereof are set according to the coordinates of the respective operation areas. In the example of FIG. 4, a range from coordinates (1, 1) to (1024, 768) of the touch panel 15F corresponds to a range (area 30F) from coordinates (1, 1) to (1024, 768) of the image 30 and is set as a movable range. Also, a range from coordinates (1, 1) to (1024, 768) of the touch panel 15R corresponds to a range (area 30R) from coordinates (1025, 1) to (2048, 768) of the image 30 and is set as a movable range.

Herein, the non-volatile memory 23 of the computer 12 stores information on a correspondence relationship between the coordinates of the image 30 and the coordinates of the operation areas of the touch panels 15F and 15R. Accordingly, based on the correspondence relationship, the computer 12 converts the position touched by a finger or the like on the detection surface of the touch panels 15F and 15R into the coordinates of the image 30. Furthermore, the information of the correspondence relationship may be kept by the touch panels 15F and 15R, and in this case, the information obtained by converting the touched position on the detection surface into the coordinates of the image 30 is output from the touch panels 15F and 15R.

For example, when the operational authority is present at the operation panel at the front side of the mounter 6, operation details of a pointer (a finger or an input pen, for example) with respect to the touch panel 15F at the front side are obtained by a hooking process (also referred to as a message hooking process). Further, all operations performed outside the operation area (corresponding to a range from coordinates (1, 1) to (1024, 768) of the image 30) of the touch panel 15F at the front side are determined to be invalid. Only the valid pointer operation is notified to a subordinate application program 23c (see FIG. 3).

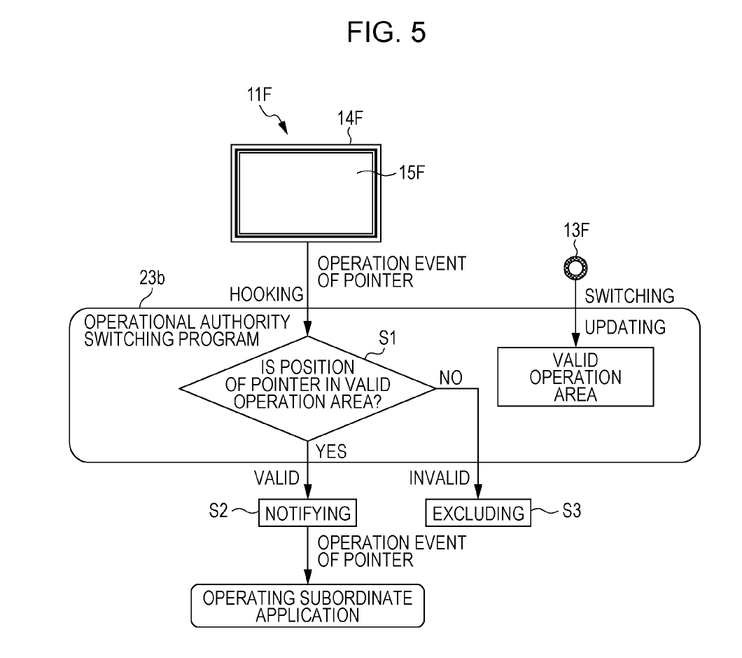

The outline of the operational authority switching program according to the embodiment will be described with reference to FIG. 5.

The operational authority switching program 23b is stored in the non-volatile memory 23 (see FIG. 3) of the computer 12, and when the control portion 21 executes this program, the operational authority switching process is performed. For example, a case where the operator pushes the switching button 13R at the front side of the operation panel of the mounter may be supposed. When the operator pushes the switching button 13F, the operational authority switching program 23b switches the operational authority from the rear surface to the front surface of the operation panel and updates the valid operation area from the touch panel 15R at the rear side to the touch panel 15F at the front side.

Thereafter, when a pointer operation event occurs with respect to the touch panel 15F while the operational authority is present at the front side, the operational authority switching program 23b determines whether the position of the pointer is in the valid operation area by the hooking process (step S1). When the position is in the valid operation area, the operational authority switching program 23b notifies the subordinate application program 23c that the operation event is valid (step S2). As a result, the subordinate application program 23c is operated. On the other hand, when the position of the pointer is not in the valid operation area, the operation event is determined to be invalid and excluded from execution subjects (step S3).

As described above taking the mounter 6 for example, each process machine of the substrate producing apparatus 1 to which the operational authority switching device with touch panels is applied serves the following functions.

(1) The process machine switches the operational authority of a plurality of touch panels with one computer.

(2) The process machine selects at which side the operational authority is present between the front side and the rear side of the process machine by the operation of turning ON and OFF of the switching button of the hardware.

(3) When the operational authority is present in the touch panel at the front side, the process machine sets the range of image area (for example, from coordinates (1, 1) to (1024, 768) of the image 30) displayed on the display panel of the operation panel at the front side as the valid operation area.

(4) When the operational authority is present in the touch panel at the rear side, the process machine sets the range of image area (for example, from coordinates (1025, 1) to (2048, 768) of the image 30) displayed on the display panel of the operation panel at the rear side as the valid operation area.

(5) The process machine hooks (captures) the operation event of a pointer by a resident type program (application program).

(6) When the operation event of a pointer occurs outside the valid operation area according to the operational authority, the process machine excludes the event and does not notify the event to the subordinate application program.

(7) When the operation event of a pointer occurs inside the valid operation area according to the operational authority, the process machine notifies the event to the subordinate application program.

### [Operational Authority Switching Process]

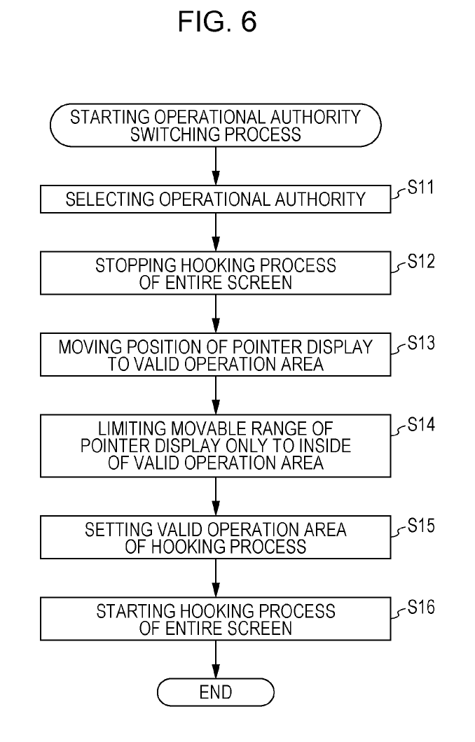

Next, the operational authority switching process performed by the operational authority switching program 23b will be described in detail with reference to the flowchart in FIG. 6.

First, by the ON and OFF operations of the switching buttons 13F and 13R, at which side the operational authority is present between the front side and the rear side of the process machine is selected (step S11). The control portion 21 (see FIG. 3) of the computer 12 detects a pushed button between the switching buttons 13F and 13R and provides the operational authority to the pushed switching button. Hereinafter, description will be made on the assumption that the switching button 13F at the front side is pushed.

Subsequently, the control portion 21 stops the hooking process of the entire screen, that is, of the touch panel 15F at the front side of the process machine (step S12).

Thereafter, the control portion 21 controls the display processing portion 22 in order to display the pointer in the display panel 14F (valid operation area) at the front side (step S13). That is, a range from coordinates (1, 1) to (1024, 768) of the image 30 is set as the valid operation area. Further, the control portion 21 limits the movable range of the displayed pointer only to the inside of the touch panel 15F (valid operation area) corresponding to the display panel 14F at the front side (step S14).

When the pointer operation has been performed with respect to the touch panel 15F (valid operation area) superimposed on the display panel 14F at the front side, the control portion 21 is set such that the hooking process is performed (step S15). That is, when the pointer operation has been performed with respect to a range from coordinates (1, 1) to (1024, 768) of the image 30, the control portion 21 performs the hooking process.

The control portion 21 starts the hooking process of the entire screen, that is, of the touch panel 15F at the front side of the process machine (step S16). After the completion of this process, the control portion 21 ends the operational authority switching process.

In the example of FIG. 6, although a pointer display in the processes of steps S13 and S14 was mentioned, this is an example of a case where the pointer display is performed. For example, the example may be applied to a case where an external input device such as a mouse is connected to the computer 12 so as to be able to be used. However, when the pointer display is not performed, the process of step S13 is not necessary, and the process of step S14 is performed to “limit the range in which an operator can input only to the inside of the touch panel 15F (valid operation area) corresponding to the display panel 14F at the front side.”

### [Safety Lock]

It is preferable to provide a safety lock in actual mounters including the mounter 6 to perform the above described operational authority switching while preventing false operation. The following configurations can be considered as the safety lock, for example.
A configuration in which, even when the mechanical button is pushed, the application program can lock so that the operational authority fails to be switched while a specific operation is performed at the side where the operational authority is present.
A configuration in which, when the interlock is turned OFF, a specific dangerous operation is not performed regardless of the operational authority.
A configuration in which, when the door of the process machine is opened, a specific dangerous operation is not performed regardless of the operational authority.
A configuration in which, when the door of the process machine is opened, the speed of a specific dangerous operation is automatically slowed down regardless of the operational authority.
A configuration in which a sensor is provided inside the process machine to stop operation (emergency stop) regardless of the operational authority when a foreign substance (a person's hand or the like) is inserted inside the process machine.
A configuration in which emergency stop buttons are provided on the operation panels at the front and rear sides of the process machine so that the emergency stop of the process machine can be performed regardless of the operational authority.

### [Hooking Process]

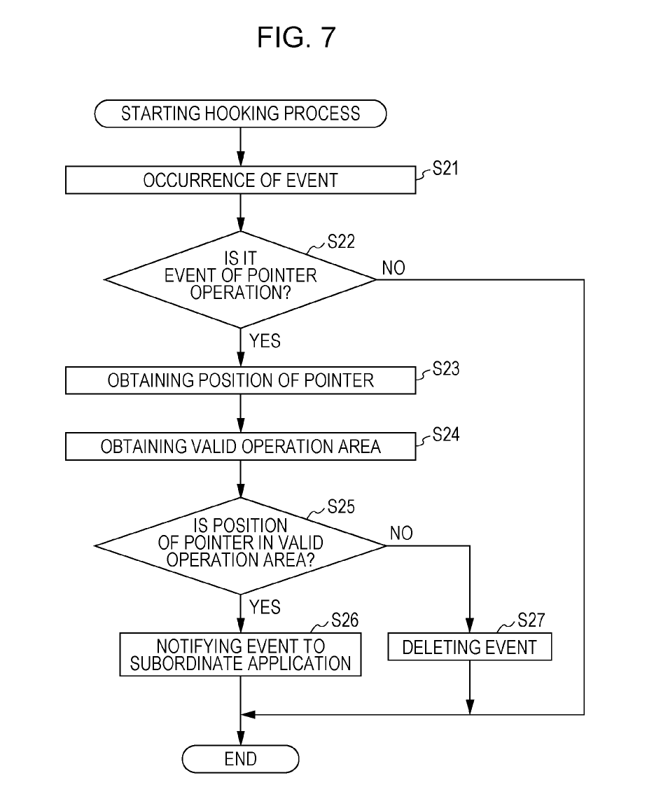

Next, the hooking process by the operational authority switching program 23b will be described in detail with reference to the flowchart in FIG. 7.

First, when detecting occurrence of an event (step S21), the control portion 21 of the computer 12 determines whether the event results from the pointer operation (step S22). The pointer operation refers to the operation with respect to the touch panel. When it is not an event resulting from the pointer operation such as an external device operation, the hooking process ends.

When it is determined to be an event resulting from the pointer operation in step S22, the control portion 21 obtains an indicated position of a pointer (the operator's finger, an input pen or the like) on the detection surface of the touch panel (step S23). Then the control portion 21 obtains the valid operation area (step S24). That is, the control portion 21 determines to which touch panel the operational authority has been allocated.

Herein, the control portion 21 determines whether the indicated position on the detection surface of the touch panel is in the valid operation area, that is, on the detection surface of the touch panel to which the operational authority has been allocated (step S25). When it is assumed that the operational authority has been allocated to the touch panel 15F at the front side, a range from coordinates (1, 1) to (1024, 768) of the image 30 is the valid operation area.

When the indicated position on the detection surface of the touch panel is in the valid operation area in step S25, the control portion 21 notifies the subordinate application program 23c that the event is valid (step S26).

On the other hand, when the indicated position on the detection surface of the touch panel is not in the valid operation area, the control portion 21 regards the event as invalid and deletes it (step S27). After completion of the process of step S26 or S27, the hooking process ends.

### [Specific Example of Operational Authority Switching]

Herein, two examples will be described as specific examples of the operational authority switching.

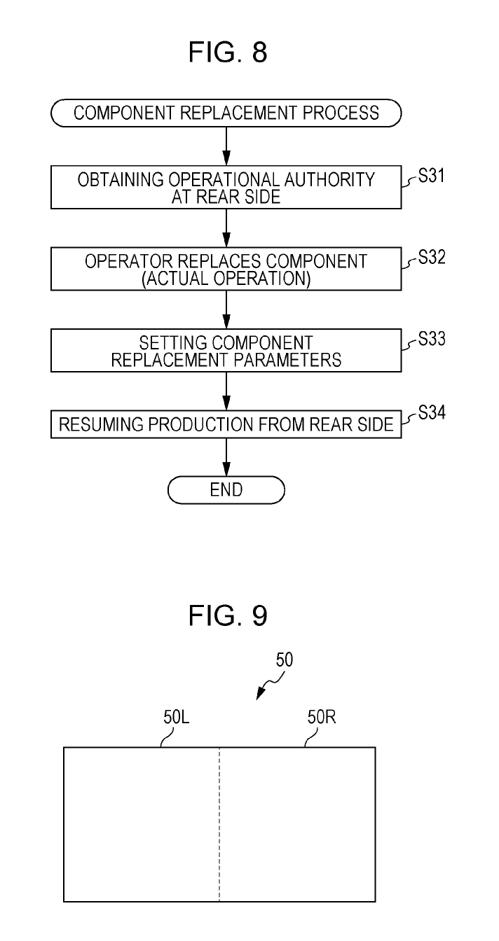

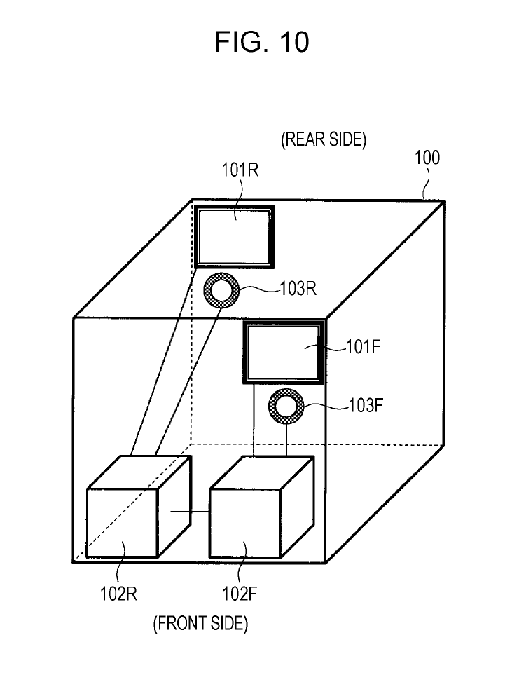

A first specific example is a pattern in which the operational authority is switched (from front to rear) to replace components since a supply portion at the rear side of the mounter 6 has run out of the components during production. FIG. 8 illustrates a flowchart of a component replacement process.

(1) First, the operator 10R at the rear side pushes the switching button 13R and obtains the operational authority at the rear side of the mounter 6 (step S31).

(2) The operator 10R stops the operation of the supply portion at the rear side and replaces components (an actual task) (step S32).

(3) The operator 10R sets component replacement parameters (a component ID, the number of remaining components, operator information and the like) by operating the touch panel 15R (step S33).

(4) The operator 10R operates the supply portion at the rear side and resumes production (step S34).

If the operational authority fails to be switched from the front side to the rear side, it is necessary that the processes (3) and (4) are performed in the operation panel at the front side, and that an operator moves from the front side to the rear side. This operation is bothersome to the operator and is a waste of time.

A second specific example is a pattern in which the operational authority is switched (from front to rear) for calibration of the substrate producing apparatus 1, that is, for setup (adjustment) of each mechanism.

When the setup is performed on each mechanism in the substrate producing apparatus 1, it is necessary that the setup is performed at the front and the rear sides separately.

(1) First, the operator 10F at the front side pushes the switching button 13F of the mounter 6 for example and obtains the operational authority at the front side, thereby performing the setup of the front side.

(2) Subsequently, after completion of the setup of the front side, the operator 10R at the rear side pushes the switching button 13R of the mounter 6 and obtains the operational authority at the rear side, thereby performing the setup of the rear side.

According to the embodiment described above, a configuration is made in which the electric signal itself is input to the computer all the time from the touch panels at both sides without invalidating the touch panel device at the side where the operational authority is not present. Also, when there is an input from the touch panel, the input is registered if it is from a side where the operational authority is present (the event is posted to the subordinate application program). Furthermore, if the input is from a side where the operational authority is not present, a process for invalidating the event (deleting the event) is performed. In this manner, the touch panel device is not invalidated by disconnecting the serial I/O itself; rather, the event is invalidated by the input from a side where the operational authority is not present. Moreover, the operational authority switching of a plurality of touch panels by software is realized by using one computer.

Accordingly, by controlling the switching in the valid operation area by the software, it is possible to realize control of the operational authority switching without relying on the types of pointing devices, drivers, and middleware. Furthermore, since the validity and invalidity of the operational authority are instantly switched to each other, it is possible to realize the operational authority switching of a plurality of touch panels (valid operation areas).

Therefore, it is possible to control both sides of a plurality of touch panels (pointing devices) by one computer and to maintain the same operability as in a case where a plurality of computers is used. Furthermore, since one computer is used, it is possible to reduce the cost.

### 2. Another Embodiment

Next, another embodiment to which the operational authority switching device with touch panels of the present disclosure is applied will be described.

In the present embodiment, one whiteboard (task area) is divided into a plurality of parts in a meeting system, and the operational authority is switched by using one computer. A whiteboard that can interact with the computer is called an interactive whiteboard. As shown in FIG. 9, an interactive whiteboard 50 is divided into a left task area 50L and a right task area 50R, and in the same manner as the above described embodiment, the operational authority is switched between the task area 50L and the task area 50R by using the switching buttons to perform exclusive control.

In the above described embodiment, two touch panels provided at the front and rear sides of the mounter were exemplified. However, three or more of the touch panels may be used so as to exclusively control the switching of the operational authority.

Also, in the above described embodiment, as an example of a position input device, a touch panel employing a method of directly detecting the position of the detection surface that a pointing object touches was described. However, the present disclosure is not limited thereto. For example, a position input device employing an optical method using a camera, a method using the position, movement and a blink of the eye and a method using the change in a brainwave can be applied.

Furthermore, a recording medium in which a program code of the software realizing the function of the above described embodiment has been recorded may be supplied to the system or device. Needless to say, the function can be realized when a computer (or a control device such as CPU) of the system or device reads and executes the program code stored in the recording medium.

As the recording medium for supplying the program code in this case, for example, a flexible disk, a hard disk, an optical disc, a magnetooptical disc, a CD-ROM, a CD-R, a magnetic tape, a non-volatile memory card and a ROM can be used.

By executing the program code that the computer reads, the function of the above described embodiment is realized. In addition, based on the instruction of the program code, the OS or the like operating in the computer performs a part or the entire actual process, and a case where the function of the above described embodiment is realized by this process is also included.

In the present disclosure, it is not necessary that the process steps are performed in a time-series manner. The process steps describing the processes in a time-series manner also include processes performed in a parallel manner or separately (for example, a parallel process or a process performed by an object) as well as processes performed in a time-series manner in the disclosed order.

The present disclosure contains subject matter related to that disclosed in Japanese Priority Patent Application JP 2010-158228 filed in the Japan Patent Office on Jul. 12, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An operational authority switching device with touch panels comprising:
a plurality of display panels;
a plurality of touch panels provided so as to be paired with each of the plurality of display panels;
a plurality of switching buttons provided in association with each of the plurality of touch panels;
a storage portion storing an operational authority switching program for switching the operational authority on the plurality of touch panels;
a control portion executing an operational authority switching program stored in the storage portion;
a display processing portion generating images based on instructions of the control portion; and
a division portion dividing the images generated in the display processing portion into a plurality of areas and outputting each image corresponding to the divided areas to each of the plurality of display panels,
wherein when one switching button is pushed, the control portion sets an operation area of the touch panel corresponding to the pushed switching button as a valid operation area to make operations with respect to the valid operation area of the corresponding touch panel valid.

2. The device according to claim 1,
wherein when one switching button is pushed, one area of the image divided in the division portion corresponds to the valid operation area of one touch panel, and,
when another switching button is pushed, another area of the image divided in the division portion corresponds to the valid operation area of another touch panel.

3. The device according to claim 2,
wherein the control portion notifies an application program that operation events occurring in the valid operation area of the touch panel are valid and invalidates events occurring outside the valid operation area of the touch panel.

4. A program executed in an operational authority switching device with touch panels including: a plurality of display panels; a plurality of touch panels provided so as to be paired with each of the corresponding plurality of display panels; a plurality of switching buttons provided in association with each of the corresponding plurality of touch panels; a display processing portion generating images; and a division portion dividing the images generated in the display processing portion into a plurality of areas and outputting each image corresponding to the divided areas to each of the plurality of display panels,
the program causing a computer to function as a control portion which sets, when one switching button is pushed, an operation area of the touch panel corresponding to the pushed switching button as a valid operation area to make operations with respect to the valid operation area of the corresponding touch panel valid.

5. An operational authority switching device with touch panels comprising:
a plurality of display panels;
a plurality of touch panels provided so as to be paired with each of the corresponding plurality of display panels; and
a control portion executing an operational authority switching program for switching operation authorities on the corresponding plurality of touch panels,
wherein a valid operation area of each touch panel is limited to a display screen of the plurality of display panels set in association with each corresponding touch panel, and
the control portion executes the operational authority switching program to switch setting of the valid operation area with respect to each operation area of the plurality of touch panels, thereby exclusively controlling operations performed in the operation areas of the plurality of touch panels simultaneously.

6. A program executed in an operational authority switching device with touch panels including: a plurality of display panels; and a plurality of touch panels provided so as to be paired with each of the corresponding plurality of display panels, wherein a valid operation area of each touch panel is limited to a display screen of the plurality of display panels set in association with each corresponding touch panel,
the program causing a computer to function as a control portion which exclusively controls operations performed in the operation areas of the plurality of touch panels simultaneously by switching setting of the valid operation area with respect to each operation area of the plurality of touch panels.
